(19) United States
(12) Patent Application Publication
(10) Pub. No.: US 2025/0128667 A1
(43) Pub. Date: Apr. 24, 2025

(54) COLLAPSIBLE ROTATION MECHANISM FOR A VEHICLE DISPLAY

(71) Applicant: Fisker Inc., Manhattan Beach, CA (US)

(72) Inventors: Xionghua Wu, Manhattan Beach, CA (US); Umachandran Muralidharan, Manhattan Beach, CA (US); Dhruv Parmar, Manhattan Beach, CA (US); Venkataramana Thupakula, Manhattan Beach, CA (US)

(21) Appl. No.: 18/492,509

(22) Filed: Oct. 23, 2023

(51) Int. Cl. B60R 11/02; B60K 35/00; B60R 11/00

(52) U.S. Cl. CPC B60R 11/0235; B60K 35/00; B60K 35/22; B60K 35/53; B60R 2011/0005; B60R 2011/0047; B60R 2011/0085; B60R 2011/0092

(57) ABSTRACT

The technology disclosed herein enables a rotation mechanism for a vehicle display to collapse when a force (e.g., from an impact) is applied to the display. In a particular example, an apparatus includes a motor shaft, wherein a motor rotates the motor shaft to rotate the display. The apparatus further includes a flange positioned to overlap with the motor shaft, wherein the display is connected to the flange. Also included are one or more fasteners positioned to connect the motor shaft to the flange. The dimension and material of the fasteners enable the fasteners to fail when a specified shear force is applied to the fasteners by the flange and the motor shaft. Failure of the fasteners enables the flange to move to overlap further with the motor shaft.

### BACKGROUND

Modern vehicles include displays that enable user interfaces that often go beyond interfaces for traditional vehicle functions. For instance, many vehicles include displays for what are commonly referred to as infotainment systems. An infotainment system display may be a touchscreen and/or may receive user inputs via other input mechanisms (e.g., physical buttons or trackpads). While a user may still interact with such a display to control traditional vehicle functions, such as a vehicle radio, vehicle heating, ventilation, and air conditioning (HVAC), vehicle lighting, etc., an infotainment display may be capable of presenting far more to the user. Some infotainment systems even allow a user to watch video media on the display or play videogames via the display. Especially as displays get larger to enhance the infotainment experience, there is a chance a user in the vehicle may impact the display (e.g., in the event of a crash) and affect their safety.

### SUMMARY

The technology disclosed herein enables a rotation mechanism for a vehicle display to collapse when a force (e.g., from an impact) is applied to the display. In a particular example, an apparatus includes a motor shaft, wherein a motor rotates the motor shaft to rotate the display. The apparatus further includes a flange positioned to overlap with the motor shaft, wherein the display is connected to the flange. Also included are one or more fasteners positioned to connect the motor shaft to the flange. The dimension and material of the fasteners enable the fasteners to fail when a specified shear force is applied to the fasteners by the flange and the motor shaft. Failure of the fasteners enables the flange to move to overlap further with the motor shaft.

In another example, a method includes activating a motor connected to a motor shaft to rotate the display. A flange is positioned within the motor shaft and the display is connected to the flange. One or more fasteners are positioned through the motor shaft to connect the motor shaft to the flange. Dimension and material of the fasteners enable the fasteners to fail when a specified shear force is applied to the fasteners by the flange and the motor shaft. Failure of the fasteners enables the flange to move further into the motor shaft.

In a further example, an apparatus includes a motor shaft, wherein a motor rotates the motor shaft to rotate the display. The apparatus also includes a flange positioned to overlap with the motor shaft, wherein the display is connected to the flange, wherein the flange includes one or more rows of ratchet slots and wherein the rows are parallel to movement of the flange into the motor shaft. A tooth for each of the rows is included in the apparatus. The tooth extends from the motor shaft into a ratchet slot of the row and the tooth is pretensioned enabling the ratchet slot to slide the tooth into a next ratchet slot in the row when the flange moves into the motor shaft while preventing the tooth from moving back from the next ratchet slot.

### BRIEF DESCRIPTION OF THE DRAWINGS

FIG. 1 illustrates a vehicle having a collapsible rotation mechanism for a display.

FIG. 2 illustrates a display apparatus having a collapsible rotation mechanism for a display.

FIG. 3 illustrates a portion of a display apparatus having a collapsible rotation mechanism for a display.

FIG. 4 illustrates a cross section of a display apparatus having a collapsible rotation mechanism for a display.

FIG. 5 illustrates a cross section of a display apparatus having a collapsible rotation mechanism for a display.

FIG. 6 illustrates a cross section of a display apparatus having a collapsible rotation mechanism for a display.

FIG. 7 illustrates a cross section of a display apparatus having a collapsible rotation mechanism for a display.

FIG. 8 illustrates a cross section of a display apparatus having a collapsible rotation mechanism for a display.

### DETAILED DESCRIPTION

Vehicle interiors are typically designed with safety in mind. For instance, a dash and steering wheel of a vehicle may be designed in a manner to either absorb or, otherwise, reduce the force of a user impacting those parts of the vehicle. With larger displays becoming more prevalent, the chance of a user impacting a display is also greater. The display apparatus described herein is configured to reduce the impact force a user experiences when impacting the display (e.g., during a front-end collision of the vehicle). Moreover, the display apparatus reduces the impact force to a user while also providing a rotation mechanism for rotating the display. A rotation mechanism may be beneficial for displays of modern infotainment systems due to the new media types the systems are capable of presenting. For example, when presenting a movie in a widescreen format it may be preferable for the display to have a landscape orientation. In contrast, a portrait orientation may be preferable when driving and presenting a user interface into more typical vehicle functions (e.g., HVAC, radio, navigation, etc.). A rotation mechanism may rotate the display into either orientation to achieve the benefits of both orientations for a vehicle display.

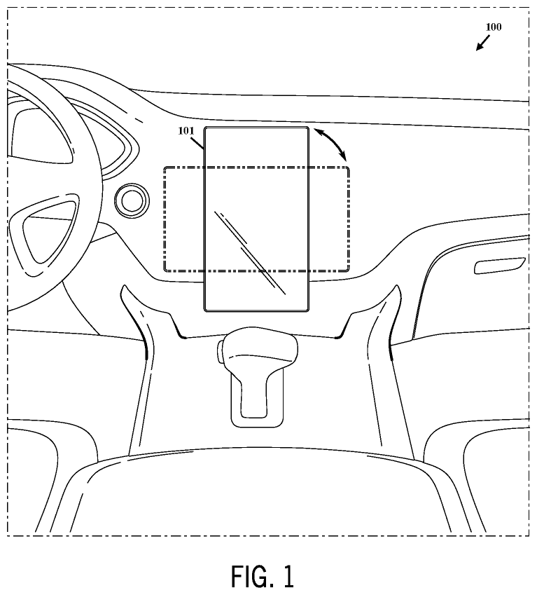

FIG. 1 illustrates vehicle 100 having a collapsible rotation mechanism for a display. Vehicle 100 is depicted from the inside facing forwards. Vehicle 100 includes display 101 as well as other common interior components (e.g., steering wheel, dash, passenger seats, gear selector, etc.). Display 101 is rotatable 90 degrees to achieve either a portrait (solid line) or landscape (dashed line) orientation. Other examples may allow display 101 to rotate more than the 90 degrees shown in this example. Vehicle 100 is merely an example design for a vehicle interior. As such, the components included in vehicle 100 may differ. Likewise, while shown as a passenger vehicle, vehicle 100 may be a car, truck, van, tractor, boat, airplane, or any other type of vehicle into which a display may be installed. Likewise, while illustrated as a center display in the front of vehicle 100's interior, display 101 may be installed elsewhere in vehicle 100, such as behind the front seats for viewing by rear passengers of vehicle 100.

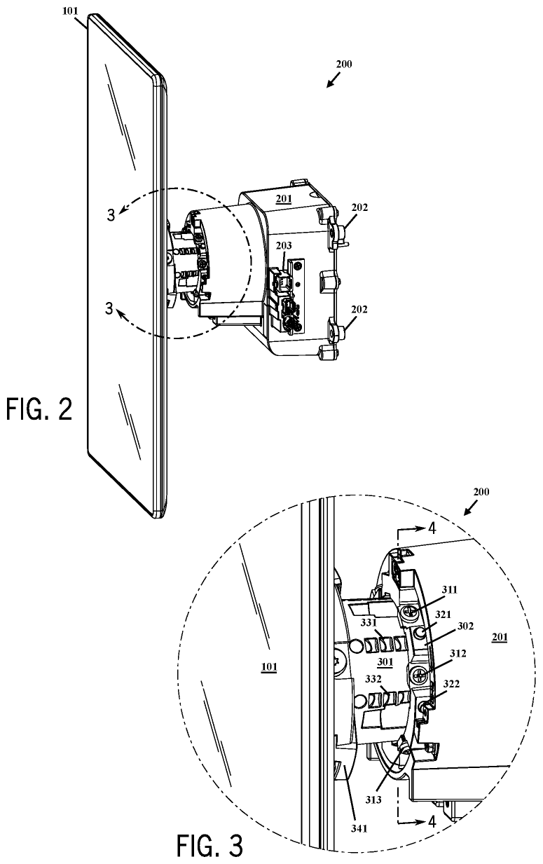

FIG. 2 illustrates display apparatus 200 having a collapsible rotation mechanism for a display. Display apparatus 200 includes display 101, housing 201, bolt holes 202, and wire connectors 203. Housing 201, bolt holes 202, and wire connectors 203 cannot be seen in FIG. 1 due to being located behind display 101. In this example, housing 201 includes bolt holes 202 for securing display apparatus 200 to vehicle 100 but other mechanisms for installing display apparatus 200 in a vehicle may be used. Wire connectors 203 are an example of how wires may be connected to display apparatus 200 to receive electrical power and exchange communications, such as video signals sent to display 101 and user input received from display 101. One or more of wire connectors 203 may connect display apparatus 200 to a processor-based compute unit for vehicle 100, either directly or networked through other systems/devices. The compute unit may control what display 101 displays by providing a video signal to display 101. The compute unit may further receive input from a user via display 101, or other user input mechanism, and act according to the input. For example, the compute unit may receive input requesting display 101 be rotated and the compute unit may send a control signal to display apparatus 200 instructing display apparatus 200 to activate a motor therein to rotate display 101 accordingly (e.g., from landscape to portrait orientation or vice versa).

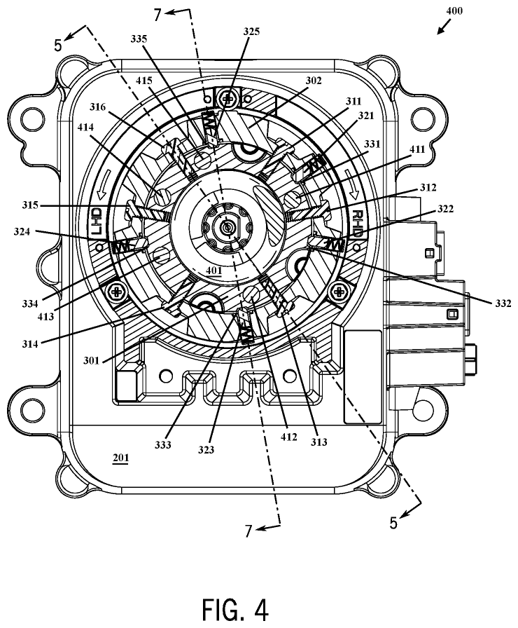

FIG. 3 illustrates a zoomed-in portion of display apparatus 200 having a collapsible rotation mechanism for a display. The portion of display apparatus 200 illustrated in FIG. 3 is indicated by the dashed circle labelled 3 in FIG. 2. FIG. 3 illustrates that display apparatus 200 further includes fasteners 311-313 connecting flange 301 of display apparatus 200 and motor shaft 302 of display apparatus 200 where flange 301 and motor shaft 302 overlap such that flange 301 is prevented from moving further into or out of motor shaft 302. Additional fasteners 314-316 cannot be seen from the angle provided in FIG. 3 but are shown in FIG. 4. In this example, flange 301 and motor shaft 302 are cylindrical in nature with flange 301 having a smaller diameter such that flange 301 fits within motor shaft 302. In other examples, flange 301 may have a larger diameter than motor shaft 302 such that motor shaft 302 fits within flange 301. Display 101 is connected to flange 301 such that display 101 rotates when flange 301 and motor shaft 302 are rotated. A motor connected to motor shaft 302 may drive the rotation of motor shaft 302 by being connected directly thereto or connected to motor shaft 302 via one or more belts, chains, gears, or some other power transfer mechanism. In this example, display 101 is connected to flange 301 via friction locking mechanism 341, which may be further secured from coming loose by one or more fasteners, such as screws. Other mechanisms for attaching a display may also be used.

When fasteners 311-316 fail, fasteners 311-316 can no longer maintain the same overlap between flange 301 and motor shaft 302. Flange 301 is, therefore, able to slide further into motor shaft 302. The material, dimensions, and number of fasteners (six in this example) used in display apparatus 200 are at least some of the parameters that determine how much sheer force will cause fasteners 311-316 to fail (e.g., break perpendicular to their length). The sheer force may be applied when a force towards flange 301 is applied to the display, which transfers that force to flange 301. The force on flange 301 in turn transfers the force to fasteners 311-316. The material may be a type of plastic, a type of metal, a type of composite, or some other material in which a fastener can be produced-including combinations thereof. Certain materials may be stronger than others in terms of their resistance to fail when a force is applied. Similarly, a larger fastener (e.g., a larger diameter) in a given material may be stronger than a smaller fastener of the same material. More fasteners in the aggregate are typically stronger than fewer fasteners.

Changing the parameters may then change the amount of force that will cause fasteners 311-316 to fail. It is possible for two different parameter combinations to have a similar amount of force causing failure (e.g., a larger size of one material may fail at the same force of a smaller size of another material). Thus, an amount of force can be tuned into fasteners 311-316 by adjusting the parameters. When determining the amount of force, fasteners 311-316 preferable do not fail in response to forces caused by everyday usage of vehicle 100, such as vehicle 100 hitting bumps in the road, touch inputs made to display 101, incidental contact made with display 101 (e.g., by user or object moving around the interior of vehicle 100), or some other type of contact with display 101 where the impact absorption features of display apparatus 200 would not be desired.

Also, the positioning (e.g., spacing) of fasteners 311-316 around flange 301 may affect how fasteners 311-316 fail. Even in examples where six fasteners are used like with display apparatus 200, the fasteners may be spaced differently than shown herein. It should be understood, while fasteners 311-316 are illustrated as being screws, fasteners 311-316 may be bolts, rivets, studs, or some other type of fastener that can serve the same purpose as fasteners 311-316 herein—including combinations thereof.

Preferably, the parameters of fasteners 311-316 results in a shearing force that helps minimize the chance of injury to a user (e.g., driver or passenger) of vehicle 100 in the event the user comes into contact with display 101. For example, if vehicle 100 is involved in a crash, the driver of vehicle 100 may have their head flung forward and into display 101. The impact of the user's head with display 101 may provide enough force to cause fasteners 311-316 to fail. The failure of fasteners 311-316 allows flange 301 to move further into motor shaft 302, which in turn allows display 101 to move in response to the impact. In examples, below a spring, or other type of force absorbing component (e.g., a pneumatic or hydraulic cylinder), may be positing within flange 301 to absorb the force after fasteners 311-316 have failed (i.e., to slow the rate in which flange 301 moves into motor shaft 302 and “cushion” the impact of the user's head in the above example). The spring rate may be selected to minimize the effects to a user by the user impacting display 101. The spring rate may be linear or may change depending on the amount in which the spring is compressed.

In this example, display apparatus 200 further includes ratchet slots 331 and ratchet slots 332, which are two of ratchet slots 331-335 that cannot be seen from the angle provided in FIG. 3 but are shown in FIG. 4. Each of ratchet slots 331-335 are positioned in a row parallel to movement of flange 301 into motor shaft 302. Each of ratchet slots 331-335 has a corresponding tooth of teeth 321-325. Each tooth is pretensioned so as to extend into a ratchet slot from motor shaft 302. Each ratchet slot is shaped with a side inward towards motor shaft 302 being shaped substantially parallel to the tooth so that the tooth will not be pushed out of the ratchet slot by a force pushing flange 301 in the direction of display 101 (e.g., a force applied by the spring mentioned above). The teeth in their respective slots, therefore, prevent flange 301 from moving out from motor shaft 302. In contrast, the side of the ratchet slot towards flange 301 is shaped in a slope enabling the tensioned tooth to be pushed back towards motor shaft 302 when flange 301 is forced further into motor shaft 302. Once flange 301 is pushed far enough, the tension on the tooth will force the tooth into the next ratchet slot closer to display 101. Teeth 321-325 and their corresponding ratchet slots 331-335, therefore, enable flange 301 to be pushed into motor shaft 302 while preventing flange 301 from coming back out. In this example, a slot after the last ratchet slot is a hole into which a tooth will insert since flange 301 will not go any further into motor shaft 302. The hole prevents movement of flange 301 in any direction. In other examples, the hole may be replaced by a final ratchet slot shaped like the other ratchet slots or may be shaped differently. Advantageously, when a user impacts display 101 and pushes flange 301 into motor shaft 302, flange 301 cannot rebound and push display 101 back towards the user, which could cause injury to the user.

FIG. 4 illustrates cross section 400 of display apparatus 200 having a collapsible rotation mechanism for a display. Cross section 400 is a cut out of display apparatus 200 looking through flange 301 and motor shaft 302 from the direction of display 101. The dashed line labelled 4 in FIG. 3 indicates from where in display apparatus 200 cross section 400 is taken while the arrows at the end of the line indicate the direction of the view. In cross section 400, all six of fasteners 311-316 and all five of teeth 321-325 can be seen positioned around the flange 301 and motor shaft 302. In this example, fasteners 311-316 and teeth 321-325 are all located on the same plane represented by cross section 400. In other examples, fasteners 311-316 and teeth 321-325 may be positioned on different planes from each other. Each tooth of teeth 321-325 is currently in a ratchet slot of their respective ratchet slots 331-335.

Cross section 400 further enables a view into flange 301 where coil spring 401 of display apparatus 200 is located. Coil spring 401 provides a force pushing on flange 301 outward from motor shaft 302 in the direction of display 101 with teeth 321-325 in ratchet slots 331-335 preventing flange 301 from moving. Teeth 321-325 in this example include pins with springs the pretension the pins into their respective ratchet slots 331-335. Other examples may use different mechanisms to provide the pretension for teeth 321-325. Although, when display apparatus 200 is in its normal operating mode with fasteners 311-316 unbroken, coil spring 401 may be decompressed and, when a force causes fasteners 311-316 to fail, coil spring 401 is compressed by that force. Other examples may use different forms of springs, multiple springs, a pneumatic or hydraulic cylinder, or some other mechanism to provide the force of coil spring 401. Cross section 400 further shows cross sections of guiding rods 411-415. In this example, guiding rods 411-415 run parallel to the movement of flange 301 into and out of motor shaft 302. Guiding rods 411-415 are affixed to flange 301 (screwed into flange 301 in this example) or are otherwise a part of flange 301. Guiding rods 411-415 pass through respective rod-sized holes in motor shaft 302 so that flange 301 cannot twist relative to motor shaft 302. Should flange 301 move (e.g., in response to a force being applied that also breaks fasteners 311-316), flange 301 will be forced to keep the same rotational position relative to motor shaft 302 by guiding rods 411-415. Other examples may use more or fewer guiding rods, if any, and the guiding rods may be positioned differently from what is shown in cross section 400. Since display 101 has a large cross section relative to that of flange 301, an off-center impact could cause flange 301 to twist or tilt relative to motor shaft 302 but for guiding rods 411-415 preventing flange 301 from doing so.

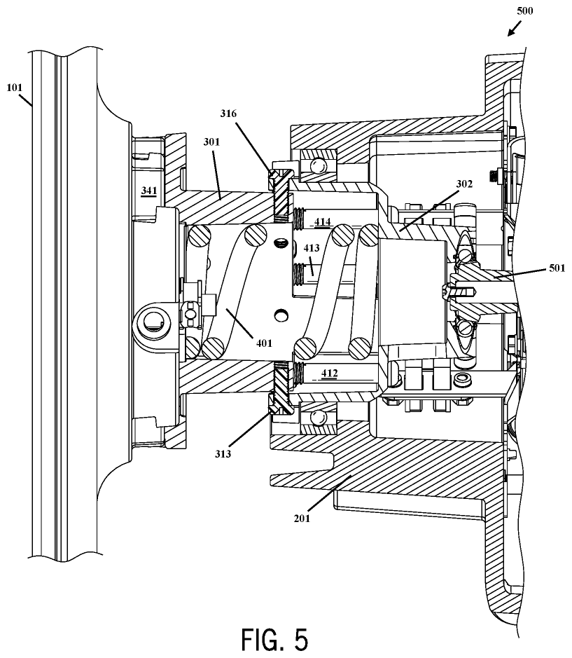

FIG. 5 illustrates cross section 500 of display apparatus 200 having a collapsible rotation mechanism for a display. Cross section 500 is cutout from a side of display apparatus 200. The dashed line labelled 5 in FIG. 4 indicates from where in display apparatus 200 cross section 500 is taken while the arrows at the end of the line indicate the direction of the view. The cutouts of cross section 500 enable flange 301, motor shaft 302, fastener 313, fastener 316, friction locking mechanism 341, coil spring 401, and guiding rods 412-414 to be seen from within housing 201. Cross section 500 further shows housing 201 includes motor output 501 from a motor connected to motor shaft 302. Coil spring 401 is positioned within flange 301 and motor shaft 302 with one end seated against motor shaft 302 and the other end seated against the display side of flange 301.

When operating normally (i.e., before a sufficient force is applied to display 101 that causes fasteners 311-316 to fail), fasteners 311-316 remain in the same position relative to flange 301 and motor shaft 302 to ensure flange 301 is held in place at its current position relative to motor shaft 302 (i.e., maintains the same overlap with motor shaft 302). As motor shaft 302 is turned by motor output 501, flange 301, fasteners 311-316, guiding rods 411-415, and display 101 turn along with it. Coil spring 401 may also turn but may not be fixed in place relative to the rotation of flange 301 and motor shaft 302.

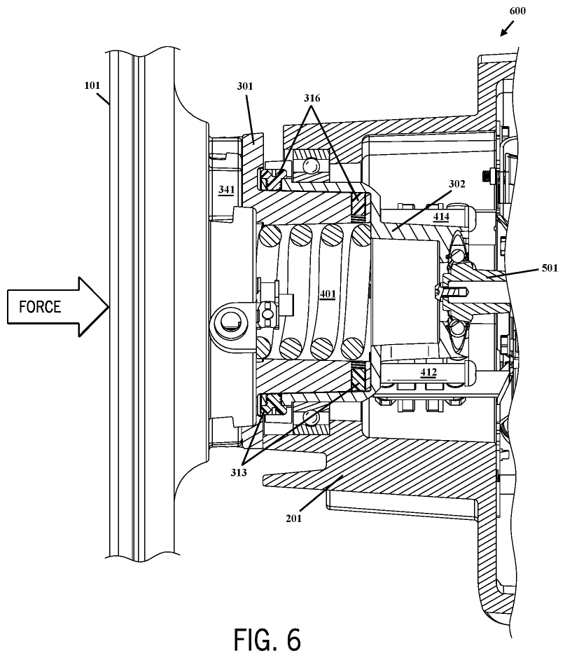

FIG. 6 illustrates cross section 600 of display apparatus display apparatus 200 having a collapsible rotation mechanism for a display. Cross section 600 is an example of cross section 500 after a force is applied to display 101. The force applied to display 101 has at least a component vector that is parallel to the direction flange 301 moves into motor shaft 302, as indicated by the force arrow in FIG. 6. The magnitude of the parallel component vector is at least enough to reach or exceed the specified sheer force on fasteners 311-316 to cause each of fasteners 311-316 to fail. Fastener 316 and fastener 313 can be seen with their respective portions protruding into flange 301 having been sheared off to move with flange 301 further into motor shaft 302. Although they cannot be seen in cross section 600, as similar failure has occurred with the remaining ones of fasteners 311-316.

Once the failure of fasteners 311-316 occurs, coil spring 401 is compressed by the force being applied to display 101. If the magnitude of the force is great enough to do so, coil spring 401 may be compressed between flange 301 and motor shaft 302 until flange 301 contacts motor shaft 302 as shown in cross section 600. During the movement of flange 301 into motor shaft 302, guiding rods 411-415 also travel through their respective holes in motor shaft 302 to direct the movement of flange 301 even when the force being applied to display 101 is not completely parallel thereto. Guiding rod 414 and guiding rod 412 are both shown in cross section 600 as having passed through motor shaft 302 but it should be understood that the other ones of guiding rods 411-415 moved similarly from their positions shown in cross section 500. Once compressed and the force abates, coil spring 401 may decompress if flange 301 is not held in position (e.g., by the ratcheting action described below). Decompressing coil spring 401 may push flange 301 back out from motor shaft 302.

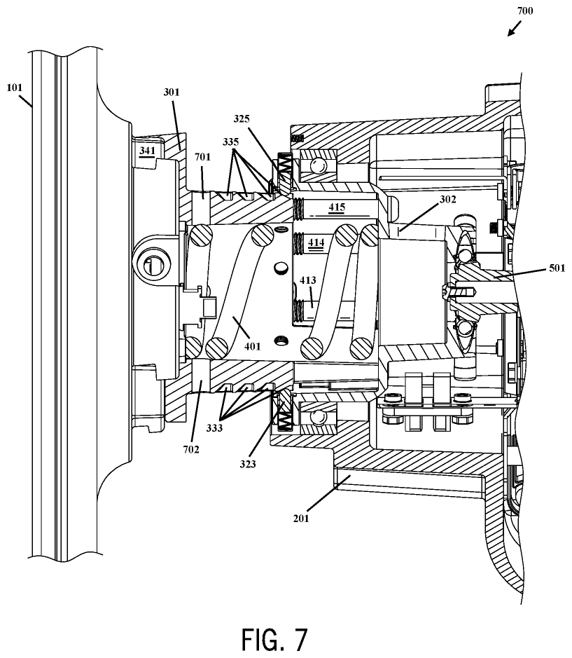

FIG. 7 illustrates cross section 700 of display apparatus 200 having a collapsible rotation mechanism for a display. Cross section 500 is cutout from a side of display apparatus 200. The dashed line labelled 7 in FIG. 4 indicates from where in display apparatus 200 cross section 700 is taken while the arrows at the end of the line indicate the direction of the view. The cutouts of cross section 700 enable flange 301, motor shaft 302, tooth 325, tooth 323, ratchet slots 335, ratchet slots 333, friction locking mechanism 341, coil spring 401, guiding rods 413-415, and motor output 501 to be seen from within housing 201. Cross section 700 further shows hole 701 and hole 702 which are holes into which tooth 325 and tooth 323, respectively, fall when flange 301 is pushed far enough into motor shaft 302. Other ones of ratchet slots 331-335 around flange 301 also include similar holes into which their respective ones of teeth 321-325 can fall.

When operating normally, teeth 321-325 remain in a slot of ratchet slots 331-335 closest to motor shaft 302, as can be seen with respect to tooth 323 and tooth 325 in cross section 700. As motor shaft 302 is turned by motor output 501, flange 301, teeth 321-325, guiding rods 411-415, and display 101 turn along with it. Coil spring 401 may also turn but may not be fixed in place relative to the rotation of flange 301 and motor shaft 302.

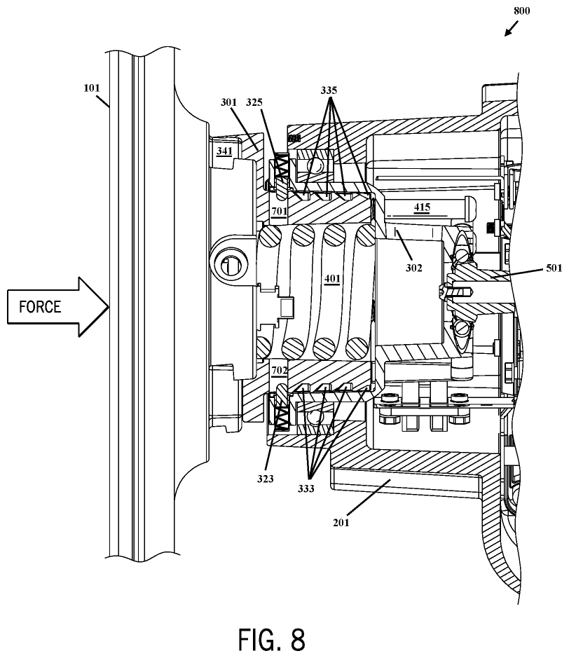

FIG. 8 illustrates cross section 800 of display apparatus 200 having a collapsible rotation mechanism for a display. Cross section 800 is an example of cross section 700 after a force is applied to display 101. Cross section 800 corresponds to cross section 600 from a different angle. Thus, fasteners 311-316 have failed as described above with respect to cross section 600 due to a force being applied to display 101 and flange 301 has moved into motor shaft 302.

In this example, once coil spring 401 has been compressed enough for hole 701 and hole 702 to line up with tooth 325 and tooth 323, respectively, tension from the springs of tooth 325 and tooth 323 pushes tooth 325 and tooth 323 into hole 701 and hole 702. Although they cannot be seen from the angle of cross section 800, other ones of teeth 321-325 will have also been pushed into their corresponding holes. Before reaching the holes, teeth 321-325 ratcheted through their respective ratchet slots 331-335 as flange 301 moved further into motor shaft 302. As can be seen in the shape of ratchet slots 335 and ratchet slots 333, the shape of ratchet slots 331-335 enables teeth 321-325 to slide out of one ratchet slot and into another as flange 301 is pushed inward. The shape of ratchet slots 331-335 being flat opposite the sloped side prevents teeth 321-325 from moving back into a previous ratchet slot due to the force of compressed coil spring 401. As such, flange 301 is prevented from moving back out of motor shaft 302 by the ratcheting action of teeth 321-325 in ratchet slots 331-335. While teeth 321-325 reach holes at the end of ratchet slots 331-335 in this example, the force on display 101 may not be enough to compress coil spring 401 that far in other examples. In those examples, teeth 321-325 may remain in whichever of ratchet slots 331-335 are reached during compression.

Advantageously, coil spring 401 is able to compress to cushion an impact to display 101 that causes fasteners 311-316 to fail. Then the ratcheting action of teeth 321-325 in ratchet slots 331-335 prevents decompression of coil spring 401 from causing a force through display 101 that also has the potential to injure the user.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. An apparatus with a collapsible mechanism for rotating a display in a vehicle, the apparatus comprising:
a motor shaft, wherein a motor rotates the motor shaft to rotate the display;
a flange positioned to overlap with the motor shaft, wherein the display is connected to the flange; and
one or more fasteners positioned to connect the motor shaft to the flange, wherein dimension and material of the fasteners enable the fasteners to fail when a specified shear force is applied to the fasteners by the flange and the motor shaft, wherein failure of the fasteners enables the flange to move to overlap further with the motor shaft.

2. The apparatus of claim 1, comprising:
a spring positioned in the motor shaft and the flange, wherein the spring compresses when the flange moves further into the motor shaft.

3. The apparatus of claim 2, wherein the spring compresses at a rate reducing an impact force to a user of the vehicle contacting the display.

4. The apparatus of claim 1, wherein the flange includes one or more rows of ratchet slots, wherein the rows are parallel to movement of the flange into the motor shaft, the apparatus comprising:
a tooth for each of the rows, wherein the tooth extends from the motor shaft into a ratchet slot of the row, wherein the tooth is pretensioned enabling the ratchet slot to slide the tooth into a next ratchet slot in the row when the flange moves into the motor shaft while preventing the tooth from moving back from the next ratchet slot.

5. The apparatus of claim 1, comprising:
one or more guiding rods parallel to movement of the flange into the motor shaft, wherein the flange includes slots for the guiding rods to guide the flange when moving further into the motor shaft.

6. The apparatus of claim 1, wherein the material comprises plastic.

7. The apparatus of claim 1, comprising:
the motor connected to the motor shaft.

8. The apparatus of claim 1, wherein the flange includes a friction locking mechanism for connection to the display.

9. The apparatus of claim 1, comprising:
a housing for the motor and the motor shaft, wherein the apparatus is installed in the vehicle using the housing.

10. A method of rotating a display of a vehicle via a collapsible mechanism, the method comprising:
activating a motor connected to a motor shaft to rotate the display, wherein:
a flange is positioned within the motor shaft,
the display is connected to the flange,
one or more fasteners are positioned through the motor shaft to connect the motor shaft to the flange,
dimension and material of the fasteners enable the fasteners to fail when a specified shear force is applied to the fasteners by the flange and the motor shaft, and
failure of the fasteners enables the flange to move further into the motor shaft.

11. The method of claim 10, wherein a spring is positioned in the motor shaft and the flange, and wherein the spring compresses when the flange moves further into the motor shaft.

12. The method of claim 11, wherein the spring compresses at a rate reducing an impact force to a user of the vehicle contacting the display.

13. The method of claim 10, wherein the flange includes one or more rows of ratchet slots, wherein the rows are parallel to movement of the flange into the motor shaft, wherein a tooth for each of the rows extends from the motor shaft into a ratchet slot of the row, wherein the tooth is pretensioned enabling the ratchet slot to slide the tooth into a next ratchet slot in the row when the flange moves into the motor shaft while preventing the tooth from moving back from the next ratchet slot.

14. The method of claim 10, wherein one or more guiding rods parallel to movement of the flange into the motor shaft guide the flange when moving further into the motor shaft.

15. An apparatus with a collapsible mechanism for rotating a display in a vehicle, the apparatus comprising:
a motor shaft, wherein a motor rotates the motor shaft to rotate the display;
a flange positioned to overlap with the motor shaft, wherein the display is connected to the flange, wherein the flange includes one or more rows of ratchet slots, wherein the rows are parallel to movement of the flange into the motor shaft; and
a tooth for each of the rows, wherein the tooth extends from the motor shaft into a ratchet slot of the row, wherein the tooth is pretensioned enabling the ratchet slot to slide the tooth into a next ratchet slot in the row when the flange moves into the motor shaft while preventing the tooth from moving back from the next ratchet slot.

16. The apparatus of claim 15, comprising:
a spring positioned in the motor shaft and the flange, wherein the spring compresses when the flange moves further into the motor shaft.

17. The apparatus of claim 16, wherein the spring compresses at a rate reducing an impact force to a user of the vehicle contacting the display.

18. The apparatus of claim 15, comprising:
one or more guiding rods parallel to movement of the flange into the motor shaft, wherein the flange includes slots for the guiding rods to guide the flange when moving further into the motor shaft.

19. The apparatus of claim 15, comprising:
the motor connected to the motor shaft.

20. The apparatus of claim 15, wherein the flange includes a friction locking mechanism for connection to the display.
